(19) United States
(12) Patent Application Publication
(10) Pub. No.: US 2006/0088154 A1
(43) Pub. Date: Apr. 27, 2006

(54) Telecommunication devices that adjust audio characteristics for elderly communicators

(75) Inventors: Adeel Mukhtar, Coral Springs, FL (US); Deepak P. Ahya, Plantation, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/970,032

(22) Filed: Oct. 21, 2004

(51) Int. Cl. H04M 9/00; H04M 1/00; H04M 1/64

(52) U.S. Cl. 379/390.01; 379/88.04; 379/388.05

(57) ABSTRACT

A telecommunication device (200) adaptable for elderly users (105). The telecommunication device can include a user classifier (205) and one or more audio processors (215 and 220). The user classifier can establish one of several categories for a device user, wherein the category determines at least one configurable setting of the telecommunication device. One of the several categories indicates that a user is elderly or subjectively elderly. The audio processors can digitally processes audio streams for the telecommunication device. At least one configurable setting can adjust operations of the audio processors so that the processors operate differently for users classified as elderly than for users not classified as elderly. The audio processors can include an incoming audio processor (215) and an outgoing audio processor (220).

### BACKGROUND

1. Field of the Invention

The present invention relates to the field of telephony and, more particularly, to a telephony device that adjusts audio characteristic for elderly communicators.

2. Description of the Related Art

Advances in medication and health have resulted in an increased average life span, which in turn results in a growing segment of elderly individuals within society. The elderly, however, often suffer from impairments like age degenerative processes, motor impairments, short-term memory problems, and reduced audio and visual capabilities. These afflictions can disadvantage the elderly whenever the elderly attempt to utilize computerized devices, which can include such telecommunication devices as mobile telephones, land-based phones, computers, personal data assistants, and the like. The disadvantages to the elderly are most pronounced in feature laden, highly miniaturized devices, such as smart mobile phones.

The special needs of the elderly, however, can be in conflict with other market segments, such as youthful users which often desire the smallest, most feature rich devices possible. Hence, mobile device designers are faced with the challenge of constructing devices that can accommodate diverse user populations.

One approach to accommodate a diverse user population is to permit a device to be configurable for the needs of each population. For example, user-selectable options can be incorporated within the device that permit users to alter the graphical user interface (GUI) of the device. These options, however, can be confusing to population segments having minimal technical abilities, which can include the elderly, who have the greatest need to configure the device. Further, traditional configuration options have focused on GUI options of a device, and have ignored other fundamental aspects of a telecommunication device, such as audio input and output. This oversight can be particularly important when an elderly individual interacts with an automated voice response system. In such interactions with automated systems, audio characteristics of the elderly individual often result in decreased speech recognition accuracy by the voice response system and often the synthetically generated speech presented to the elderly individual is difficult for the elderly individual to understand.

### SUMMARY OF THE INVENTION

One aspect of the present invention includes a telecommunication device adaptable for elderly users. The telecommunication device can include a user classifier and one or more audio processors. The user classifier can establish one of several categories for a device user, wherein the category determines at least one configurable setting of the telecommunication device.

The audio processors can digitally process audio streams for the telecommunication device. At least one configurable setting can adjust operations of the audio processors so that the processors operate differently for users classified as elderly than for users not classified as elderly.

For example, the audio processors can include an incoming audio processor that adjusts incoming audio signals before audio is presented to a user, wherein the incoming audio signals are specifically adjusted based upon the category established by the user classifier. Consequently, whenever the user of the telecommunication device is classified as elderly, the incoming audio processor can boost the high frequency bands of the incoming audio signals, can increase ring and earpiece volume of a the telecommunication device, and can perform other such adjustments.

In another example, the audio processors can include an outgoing audio processor that adjusts outgoing audio signals before the outgoing audio signals are transmitted by the telecommunication device. The outgoing audio signals can be specifically adjusted based upon the category established by the user classifier. Consequently, whenever the user of the telecommunication device is classified as elderly, the outgoing audio processor can boost the high frequency bands of the outgoing audio signals, can apply a gain to increase outgoing signal power, and can perform other such adjustments.

In one embodiment, the telecommunication device can be a mobile telephone having a graphical user interface. The graphical user interface can be specifically adjusted based upon the category established by the user classifier. For example, whenever the user is classified as elderly, the graphical user interface can be adjusted for a larger font and image size, to present fewer options, to simplify a menu structure, and the like.

In another aspect, an embodiment of the present invention can include a method for adjusting telecommunications sessions. The method can determine that a participant of a telecommunication session is elderly or subjectively elderly. Then, before presenting incoming audio signals to the determined participant, the method can adjust the incoming audio signals to increase intelligibility of presented audio. The method can also adjust outgoing audio signals to increase intelligibility of conveyed audio. The adjustments can be specific to hearing and speaking characteristics of the elderly.

It should be noted that the invention can be implemented as a program for controlling a machine to implement the functions described herein, or a program for enabling a computer to perform the process corresponding to the steps disclosed herein. This program may be provided by storing the program in a magnetic disk, an optical disk, a semiconductor memory, any other recording medium, or distributed via a network. The machine can use computing components disposed within a telephone device, components disposed within a telephony switch, and components disposed within a network element, such as a remotely located server.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate and explain various embodiments in accordance with the present invention; it being understood, however, that the invention is not limited to the precise arrangements and instrumentalities shown.

FIG. 1 is a schematic diagram of a telecommunication system that includes a telecommunication device that is adapted for an elderly user in accordance with an embodiment of the inventive arrangements disclosed herein.

FIG. 2 is a schematic diagram of a telecommunication device with internal components for adapting the device for an elderly user in accordance with an embodiment of the inventive arrangements disclosed herein.

FIG. 3 is a schematic diagram illustrating a technique for classifying a telecommunication participant as elderly based upon samples of the participant's speech in accordance with an embodiment of the inventive arrangements disclosed herein.

FIG. 4 is a schematic diagram illustrating a technique for enhancing incoming audio for an elderly telecommunication participant in accordance with an embodiment of the inventive arrangements disclosed herein.

FIG. 5 is a schematic diagram illustrating a technique for enhancing outgoing audio for an elderly telecommunication participant in accordance with an embodiment of the inventive arrangements disclosed herein.

FIG. 6 is a flow chart illustrating a method for adjusting a telecommunication session that includes an elderly participant in accordance with an embodiment of the inventive arrangements disclosed herein.

### DETAILED DESCRIPTION OF THE INVENTION

FIG. 1 is a schematic diagram of a telecommunication system 100 that includes a telecommunication device 110 that is adapted for an elderly user 105 in accordance with an embodiment of the inventive arrangements disclosed herein. The configurable telecommunication device 110 can permit the elderly user 105 to communicate with another user 120 or an automated voice response system 125 over a network 115. Audio heard by the elderly user 105 can be digitally processed before being audibly presented to the elderly user 105. Audio produced by the elderly user 105 can be digitally processed before being audibly presented to the communication recipient, the recipient being user 120 or automated voice response system 125. The digital processing of the audio input and output can occur within the telecommunication device 110, within a device of the user 120, within a component of system 125, within network 115, and combinations thereof.

The telecommunications device 110 can include a mobile telephone, a land-based phone, a computer having Voice-Over-Internet-Protocol (VOIP) capabilities, or a variety of other telecommunication devices. The network 115 can be implemented as any of a variety of fashions so long as content is conveyed using encoded electromagnetic signals. For example, the network 115 can include a public switched telephone network (PSTN), a mobile telephony network, an Internet, an intranet, and the like. Further, any of a variety of communication devices, such as customer premise equipment (CPE), computers, modems, routers, switches, wireless access points, or the like, can be included within network 115.

Additionally, the invention described herein can be practiced without the inclusion of network 115, and can instead be implemented using to or more communication units that are directly linked to each other. For example, two personal radio communication devices (walkie-talkies) can utilize the present invention, without the inclusion of network 115.

It should be appreciated that for purposes of utilizing telecommunication device 110, the elderly user 105 is defined by a series of distinguishing user characteristics that differ from an average population and not defined by the actual physical age of the user, which is irrelevant for purposes of device configuration. Any user, regardless of physical age, having these user characteristics is henceforth referred to herein as “elderly”. Notably, a physically older individual lacking these user characteristics is not considered elderly and a youthful individual possessing these user characteristics is considered elderly for purposes of the material presented herein.

User characteristics of the elderly include, but are not limited to, hearing impairments (usually involving a loss of hearing more pronounced in the high frequency bands of the human auditory range), speaking impairments (such as softer or lower powered speech, a low speech rate, trembling, and a reduced high frequency band), cognitive impairments or a lack of technological sophistication making complex interfaces cumbersome, and visual impairments making small visual displays difficult to read.

It should be further appreciated that as used herein, increasing intelligibility of presented audio or conveyed audio for an elderly listener or speaker refers to performing one or more digital signal processing (DSP) operations against audio. Audio that has been digitally processed so as to be “more intelligible” to an elderly listener can be adjusted for the hearing capabilities of a typical elderly listener. Audio from an elderly speaker that has been digitally processed so as to be “more intelligible” can be adjusted to compensate for speaking impairments and shortcomings common in elderly speakers.

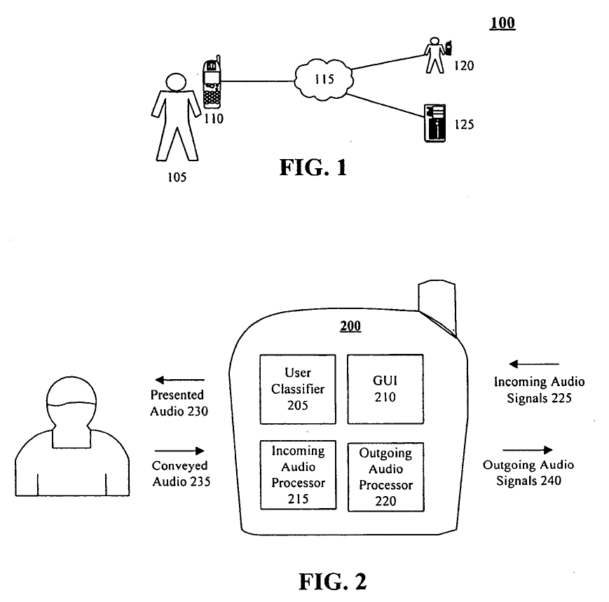

FIG. 2 is a schematic diagram of a telecommunication device 200 with internal components for adapting the device for an elderly user in accordance with an embodiment of the inventive arrangements disclosed herein. In one embodiment, the device 200 can be an implementation of device 110 shown in FIG. 1.

Telecommunication device 200 can include a user classifier 205, a graphical user interface (GUI) 210, an incoming audio processor 215, and an outgoing audio processor 220. The user classifier 205 can classify a user as one of several designated categories, which include a category indicating a user is elderly. Each category can be associated with a plurality of device 200 settings, which are adjusted responsive to category selection. The setting can cause adjustments to GUI 210, to the incoming audio processor 215, to the outgoing audio processor 220, and combinations thereof. Category selection can be an automated process invoked when the user classifier 205 detects a previously established event or can be a user triggered event resulting from a user selected configuration option available upon device 200. In one embodiment, using the user classifier algorithm as contemplated herein, an interactive voice response (IVR) system can be configured for elderly users, making it easy for elderly to use such systems.

The GUI 210 can include a variety of settings adjusted whenever the selected category indicates that a user is elderly. For example, the GUI 210 can include a wizard, avatar, or other guide for assisting a user through a configuration process. In one arrangement, the font size and graphic size for items displayed in GUI 200 can be increased when the user is classified as elderly to compensate for visual impairments of the user. In another arrangement, the menu structure and/or interface of GUI 200 can be simplified for elderly users. Further, a special help screen designed for the elderly can be invoked or activated within GUI 200. Moreover, when a user is classified as elderly, buttons and other GUI 200 selectable elements can be enlarged or spaced apart. Larger buttons with greater spaces between buttons can help improve selection accuracy when device 200 is used by an elderly user having impaired motor coordination.

The incoming audio processor 215 can adjust incoming audio signals 225 before those signals converted into presented audio 230 to increase the intelligibility of presented audio 230. This adjustment can be based upon hearing characteristics of an elderly listener, assuming the user classifier 205 indicates that the device 200 user is selectively elderly.

The outgoing audio processor 220 can adjust conveyed audio 235 produced by device 200 user before transmitting an outgoing audio signal 240 generated from the conveyed audio 235 to increase the intelligibility of conveyed audio 235. This adjustment can be based upon speaking characteristics of an elderly speaker, assuming the user classifier 205 indicates that the device 200 user is elderly.

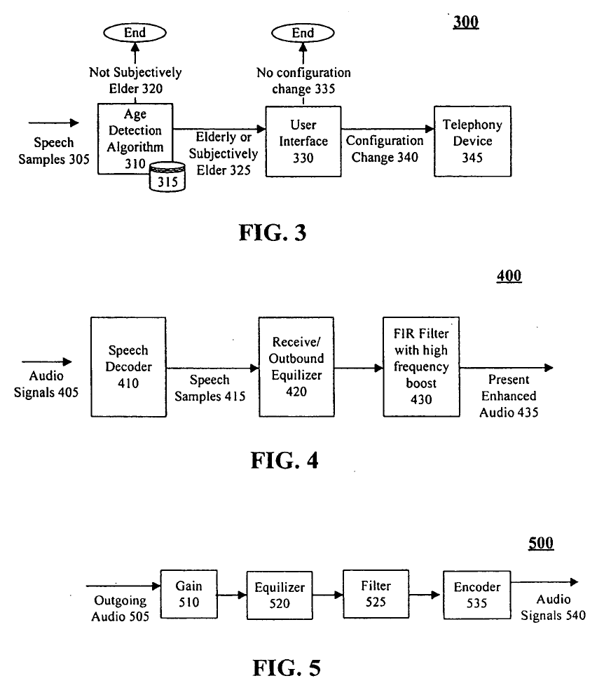

FIG. 3 is a schematic diagram illustrating a technique 300 for classifying a telecommunication participant as elderly based upon samples of the participant's speech in accordance with an embodiment of the inventive arrangements disclosed herein. In one embodiment, technique 300 can be a function performed by the user classifier 205 of FIG. 2, thereby allowing device 200 to automatically classify a user as selectively elderly based upon speech samples 305 of the user.

Technique 300 relies upon the fact that information on a speaker's age is present within the speech acoustics of a speaker. This information can be extracted by the age detection algorithm 310 to automatically determine if a speaker is elderly. It should be appreciated that any of a variety of methods can be used by the age detection algorithm 310.

For example, the age detection algorithm 310 can utilize a plurality of trained models stored in data store 315. Each model consists of a plurality of baseline values indicative of a user's age. Each model can record characteristic values for such speech acoustic features as speech rate, average energy within a speech utterance, trembling characteristics present within a typical speech utterance, characteristic power spectrum bands for segments of the voice spectrum, and the like. Models can be gender-dependent, as men and women have different characteristic speech acoustic features.

The age detection algorithm 310 can extract features from the speech samples 305 and can determine which of the models in data store 315 best matches the current speaker. In one embodiment, the age detection algorithm 310 can utilize a single-state Hidden Markov Model or a Gaussian Mixture Model (GMM) to statistically represent how a speaker produces sound, and MFCC (Mel Frequency Cepstrum Coefficients), power and speech rate as feature set and to map these features to models within data store 315.

When mapping features, features can be extracted from each frame of speech samples 305 and can be represented as elements of a multi-dimensional feature space. A correspondence score between the multi-dimensional space and each model in the data store 315 can be generated. The model with the highest correspondence score can be selected by the age detection algorithm 310. The selected model can indicate a classification category of the speaker, one such category indicating the speaker is subjectively elderly.

When the age detection algorithm 310 determines that the speaker is not elderly 320, the communication device need not be adjusted for a elderly user and the technique 300 can end.

When the age detection algorithm indicates the speaker is elderly 325, the technique can trigger one or more events of the user interface 330. One such event can result in the user interface 330 prompting the user to indicate whether the user would like to switch to an interface customized for the elderly. This prompting can, for example, occur by flashing text, producing a distinctive sound, opening a configuration window, and the like. When the user indicates that no configuration change 335 is desired, technique 300 can end. In another embodiment, once the age detection algorithm indicates that the speaker is elderly, the interface can be automatically customized for the elderly without user prompting.

When the user decides to change the configuration 340, a user friendly dialogue can be initiated within the user interface 330 to guide the user through the configuration process. This guiding configuration process can use audio as well as visual cues. After the user configuration selections are made, setting changes corresponding to the selections can be made to the telephony device 345.

FIG. 4 is a schematic diagram illustrating a technique 400 for enhancing incoming audio for an elderly telecommunication participant in accordance with an embodiment of the inventive arrangements disclosed herein. In one embodiment, technique 400 can be a function performed by the incoming audio processor 215 of FIG. 2.

According to technique 400, audio signals can be conveyed to a speech decoder 410. The speech decoder 410 can generate speech samples 415 that are conveyed to the equalizer 420. Signals from the equalizer can be passed through a Finite Impulse Response (FIR) filter with a high frequency boost 430. The resulting enhanced audio 435 can be presented to the elderly user.

It should be noted that the loss of hearing in the elderly typically starts in the high frequencies. Technique 400 can be configured at different adjustment levels, each level compensating for a different corresponding level of age-induced hearing loss. For example, one level can be for elderly users with extreme high end frequency band hearing impairments, another for moderate high end impairments, still another for slight impairments, and yet another for no high end impairments. Technique 400 can also be applied to compensate for low-end impairments.

In one embodiment, speech samples adjusted for each of the user-selectable levels can be presented to the user of the telecommunication device. The user can select the speech sample that is most intelligible. The adjustment level used in technique 400 can them be based upon the level associated with the selected speech sample.

FIG. 5 is a schematic diagram illustrating a technique 500 for enhancing outgoing audio for an elderly telecommunication participant in accordance with an embodiment of the inventive arrangements disclosed herein. In one embodiment, technique 500 can be a function performed by the outgoing audio processor 220 of FIG. 2.

According to technique 500, a gain 510 can be applied to outgoing audio 505 to remedy the problem of less energy being present in speech from elderly users when compared to energy present in speech from an average user. The adjusted audio signals can be processed by equalizer 520, and can be further processed by filter 525. Filter 525 can be a FIR filter with a high frequency boost designed to emphasize high frequency bands, although other frequency boosts are within the scope of the invention. Encoder 535 can encode the resulting processed signals to generate the audio signals 540 that are conveyed to the communication recipient.

Technique 500 can be configured at different adjustment levels, each level compensating for a different corresponding level of age-induced speech impairment. For example, one level can be for elderly users with extremely low powered voices and extreme high frequency band loss in their speech. Another level can be used for users with significant tremble in their speech. The adjustment levels can be separately adjusted to address different speech impairments, since there is no exact correlation between different types of speech impairments, the level of each being individual to the speaker.

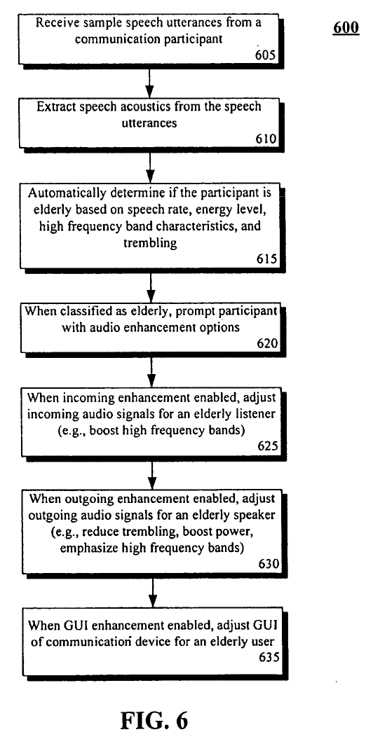

FIG. 6 is a flow chart illustrating a method 600 for adjusting a telecommunication session that includes an elderly participant in accordance with an embodiment of the inventive arrangements disclosed herein. In one embodiment, the method 600 can be performed in the context of telecommunication system 100 of FIG. 1.

The method 600 can begin in step 605, where sample speech utterances can be received from a communication participant. In step 610, speech acoustics can be extracted from the speech utterances. In step 615, an automatic determination can be made as to whether the participant is elderly. This determination can be based on factors such as speech rate, a speech energy level, high band frequency characteristics within the speech utterances, trembling in the speech utterances, and the like. In one embodiment, the determination can be based on an affirmative user input such as an entry (via keyboard, voice recognition, etc.) of a user's age or age range. If desired, such inputs can be corroborated by the previously mentioned factors or alternatively the factors can be corroborated by the affirmative user age or age range input.

In step 620, when the participant is determined to be elderly, the participant can be prompted with user-selectable audio enhancement options. These options can include options for incoming audio, outgoing audio, and GUI enhancement. Further, these options can be default settings that can be automatically applied without explicitly prompting the user.

In step 625, when the incoming audio enhancements are enabled, incoming audio signals can be adjusted in real-time or near real-time to increase the intelligibility of presented audio for an elderly listener. For example, the high frequency bands of the incoming audio signal can be boosted. In another example, the incoming audio can be slowed down so as to make the incoming audio more understandable for the elderly listener.

In step 630, when the outgoing audio enhancements are enabled, outgoing audio signals can be adjusted in real-time or near real-time to increase the intelligibility of the outgoing audio signals for an elderly speaker. For example, elderly speakers typically speak with significant trembling, low power, and with insufficient emphasis on the high frequency bands. The outgoing audio signals can be adjusted to reduce trembling, to boost power, and to emphasize the high frequency bands.

In step 635, when GUI enhancements are enabled, the GUI of the communication device of the elderly person can be modified for increased ease-of-use. For example, whenever the user is classified as elderly, the graphical user interface can be adjusted for a larger font and image size, to present fewer options, to simplify a menu structure, and the like.

The present invention can be realized in hardware, software, or a combination of hardware and software. A system according to an exemplary embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for adjusting telecommunications sessions comprising the steps of:
determining that a participant of a telecommunication session is elderly;
before presenting incoming audio signals to the determined participant, adjusting the incoming audio signals to increase intelligibility of presented audio, wherein the incoming signal adjustment is an adjustment based upon hearing characteristics of elderly listeners; and
before conveying outgoing audio signals from the determined participant, adjusting the outgoing audio signals to increase intelligibility of conveyed audio, wherein the outgoing signal adjustment is an adjustment based upon speaking characteristics of elderly speakers.

2. The method of claim 1, wherein the determining step further comprises the step of:
automatically determining that the participant is elderly based upon speech acoustics detected within speech utterances of the participant.

3. The method of claim 2, wherein the speech acoustics used by the automatically determining step are based upon at least one of a lower speech rate than an established baseline speech rate, less energy within the speech utterances than an established baseline energy level, trembling within the speech utterances, a power spectrum in higher frequency bands of the speech utterances that is less than an established baseline power spectrum.

4. The method of claim 2, further comprising the step of:
upon determining that the participant is elderly, prompting the participant with at least one option to enhance audio during the telecommunication session, wherein the at least one option permits the participant to selectively enable features relating to the steps of adjusting the incoming audio signals and adjusting the outgoing audio signals.

5. The method of claim 1, wherein the step of adjusting incoming audio signals boosts the high frequency bands of the incoming audio signal.

6. The method of claim 5, wherein the step of adjusting incoming audio signals comprises the steps of:
permitting the participant to determine an extent that the high frequency bands are boosted based upon a user selection of a plurality of audio samples, each of said audio samples corresponding to at least one parameter used to adjust the high frequency bands.

7. The method of claim 1, wherein the step of adjusting outgoing audio signals applies a gain factor to the outgoing audio signals to increase power of the outgoing audio signals.

8. The method of claim 7, wherein the step of adjusting outgoing signals comprises a step of boosting a high frequency component of the outgoing audio signals.

9. The method of claim 1, further comprising the step of:
adjusting a graphical user interface used by the participant during the communication session, wherein the graphical user interface adjustment is an adjustment based upon visual characteristics of elderly users.

10. The method of claim 9, wherein the adjusting of the graphical user interface includes at least one of increasing font size, simplifying a menu structure of the graphical user interface, presenting fewer user options within the graphical user interface, and increasing a size of displayed graphics.

11. A machine-readable storage having stored thereon, a computer program having a plurality of code sections, the code sections executable by a machine for causing the machine to:
determine that a participant of a telecommunication session is elderly;
before incoming audio signals are presented to the determined participant, adjust the incoming audio signals to increase intelligibility of presented audio, wherein the incoming signal adjustment is an adjustment based upon hearing characteristics of elderly listeners; and
before outgoing audio signals are conveyed to a party of the telecommunication session with whom the determined participant is communicating, adjust the outgoing audio signals to increase intelligibility of conveyed audio, wherein the outgoing signal adjustment is an adjustment based upon speaking characteristics of elderly speakers.

12. The machine-readable storage of claim 11, wherein the machine containing the machine-readable storage is a telephony device of the determined participant.

13. The machine-readable storage of claim 12, wherein the telephony device is a mobile telephone.

14. The machine-readable storage of claim 12, wherein the telephony device comprises a graphical user interface including a plurality of user-configurable options, wherein at least one of the user-configurable options causes the machine to adjust the incoming audio signals, and wherein at least one of the user-configurable options causes the machine to adjust the outgoing audio signals.

15. The machine-readable storage of claim 14, wherein at least one of the user configurable options adjusts the graphical user interface based upon visual characteristics of elderly users.

16. A telecommunication device comprising:
a user classifier configured to establish one of a plurality of categories for a device user, wherein the category determines at least one configurable setting of the telecommunication device, wherein one of the plurality of categories indicates that a user is elderly;
at least one audio processor that digitally processes audio streams for the telecommunication device, wherein one of the at least one configurable setting adjusts operations of the at least one audio processor so that the at least one processor operates differently for users classified as elderly than for other users.

17. The telecommunication device of claim 16, wherein the at least one audio processor comprises:
an incoming audio processor configured to adjust incoming audio signals before being presented as audio to a user, wherein the incoming audio signals are specifically adjusted based upon the category established by the user classifier.

18. The telecommunication device of claim 16, wherein the at least one audio processor comprises:
an outgoing audio processor configured to adjust outgoing audio signals before being transmitted by the telecommunication device, wherein the outgoing audio signals are specifically adjusted based upon the category established by the user classifier.

19. The telecommunication device of claim 16, wherein the telecommunication device is a mobile telephone having a graphical user interface, wherein the graphical user interface is specifically adjusted based upon the category established by the user classifier.

20. The telecommunication device of claim 16, wherein the user classifier operates cooperatively with an interactive voice response system configured specifically for at least one of listening and speaking characteristics of users classified as elderly.
